(19) United States
(12) Patent Application Publication
(10) Pub. No.: US 2008/0111501 A1
(43) Pub. Date: May 15, 2008

(54) Wall-mountable smart dual load control device

(75) Inventors: Aaron Dobbins, Macungie, PA (US); Kyle A. McCarter, Bethlehem, PA (US)

Correspondence Address: LUTRON ELECTRONICS CO., INC.;MARK E. ROSE, 7200 SUTER ROAD, COOPERSBURG, PA, 18036-1299, US

(73) Assignee: Lutron Electronics Co., Inc.

(21) Appl. No.: 11/598,460

(22) Filed: Nov. 13, 2006

(51) Int. Cl. H05B 41/38

(52) U.S. Cl. 315/294; 315/131; 315/201

(57) ABSTRACT

A smart dual load control device is operable to control the amount of power delivered from an AC power source to a first electrical load and to switch the power delivered from the AC power source to a second electrical load between an on state and an off state, while providing an advanced set of control features and feedback options to an end user. A control circuit is coupled to first and second controllably conductive devices for controlling the amount of power delivered to the first and second electrical loads, respectively. A power supply generates a DC voltage to power the control circuit and is coupled in parallel electrical connection with the first controllably conductive device such that the power supply is operable to draw current through the first electrical load. The second controllably conductive device is operable to provide substantially zero current through the second electrical load when the second electrical load is in the off state.

### BACKGROUND OF THE INVENTION

1. Field of the Invention

The present invention relates to dual load control devices for independently controlling the amount of power delivered to two electrical loads from a source of alternating-current (AC) power, and more particularly, to a smart load control device for dimming a first electrical load and switching a second electrical load.

2. Description of the Related Art

Often, two electrical loads are controlled from a wall-mountable load control device mounted in a single-gang electrical wallbox. For example, a lighting load and a motor load, such as an exhaust fan, are often controlled from a single wall-mountable load control device in a bathroom. A common single-gang load control device for control of two electrical loads is a dual switch, which simply comprises a first mechanical switch coupled in series between an AC power source and the first electrical load, and a second mechanical switch coupled in series between the AC power source and the second electrical load.

Another prior art single-gang load control device for control of two electrical loads is an analog dual dimmer and fan speed control for independent control of the intensity of a connected lighting load and the speed of a connected motor load. The dual dimmer and fan speed control comprises separate load control circuits for controlling the amount of power delivered to the lighting load and the fan motor. Specifically, a phase-control dimmer circuit controls the intensity of the lighting load and a fan speed control circuit controls the speed of the fan motor. The dual dimmer and fan speed control includes two adjustment actuators (e.g., slider controls) for independent adjustment of each of the intensity of the lighting load and the speed of the fan motor.

Some prior art single-gang wall-mountable “smart” dimmers are operable to control the amount of power delivered to a single lighting load (or a plurality of parallel-connected lighting loads in unison). A smart dimmer is one that includes a microcontroller or other processing means for providing an advanced set of control features and feedback options to the end user. For example, the advanced features of a smart dimmer may include a protected or locked lighting preset, fading, and double-tap to full intensity. The microcontroller controls the conduction times of a bidirectional semiconductor switch to control the intensity of the lighting load. To power the microcontroller, smart dimmers include power supplies, which are coupled in parallel with the semiconductor switch and draw a small amount of current through the lighting load each half-cycle when the semiconductor switch is non-conducting. An example of a smart dimmer is described in greater detail in U.S. Pat. No. 5,248,919, issued Sep. 29, 1993, entitled LIGHTING CONTROL DEVICE, the entire disclosure of which is hereby incorporated by reference.

There is a need for a dual load control device that is operable to control the amount of power delivered to a first electrical load, to switch the power delivered to a second electrical load, and to provide an advanced set of control features and feedback options to an end user.

### SUMMARY OF THE INVENTION

According to the present invention, a wall-mountable load control device for individually controlling the power delivered from an AC power source to a first electrical load and a second electrical load is provided. The AC power source has a hot connection and a neutral connection, and the first and second electrical loads each have a first connection and a second connection. The second connections of both the first and second electrical loads are coupled to the neutral connection of the AC power source. The load control device comprises first and second controllably conductive devices, a control circuit, and a power supply. The first controllably conductive device has a control input and is adapted to be coupled between the hot connection of the AC power source and the first connection of the first electrical load for controlling the amount of power delivered to the first electrical load continuously from a maximum value to a minimum value. The second controllably conductive device also has a control input and is adapted to be coupled between the hot connection of the AC power source and the first connection of the second electrical load for switching the second electrical load between an on state and an off state. The control circuit is coupled to the control inputs of the first and second controllably conductive devices to control the first and second controllably conductive devices. The power supply is operable to generate a DC voltage for powering the control circuit. The power supply is coupled in parallel electrical connection with the first controllably conductive device, such that the power supply is operable to draw current through the first electrical load. The second controllably conductive device is operable to provide substantially zero current through the second electrical load when the second electrical load is in the off state. Further, the load control device is not adapted to be coupled to the neutral connection of the AC power source.

According to a second embodiment of the present invention, a wall-mountable load control device for controlling the power delivered from an AC power source independently to a first electrical load and a second electrical load, comprises a plurality of terminals, first and second controllably conductive devices, and a control circuit. The plurality of terminals consist of a first terminal adapted to be coupled to the AC power source, a second terminal adapted to be coupled to the first electrical load, and a third terminal adapted to be coupled to the second electrical load. The first controllably conductive device is operatively coupled between the first terminal and the second terminal, while the second controllably conductive device is operatively coupled between the first terminal and the third terminal. The first and second controllably conductive devices each have control inputs. The control circuit is coupled to the control inputs of the first and second controllably conductive devices to control each of the first and second controllably conductive devices independently between a conductive state and a non-conductive state. The second controllably conductive device is operable to provide substantially zero current through the second electrical load when the second controllably conductive device is in the non-conductive state.

Other features and advantages of the present invention will become apparent from the following description of the invention that refers to the accompanying drawings.

### BRIEF DESCRIPTION OF THE DRAWINGS

FIG. 1 is a front view of a smart dual switch/dimmer operable to independently control two separate electrical loads according to the present invention;

FIG. 2 is a simplified block diagram of the dual switch/dimmer of FIG. 1;

FIG. 3 is a flowchart of a control procedure executed periodically by a microprocessor of the dual switch/dimmer of FIG. 2;

FIGS. 4A and 4B are flowcharts of a dimmer procedure of the control procedure of FIG. 3;

FIG. 5 is a flowchart of a switch procedure of the control procedure of FIG. 3; and

FIG. 6 is a front view of a dual timer/dimmer operable to independently control two separate electrical loads according to a second embodiment of the present invention.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

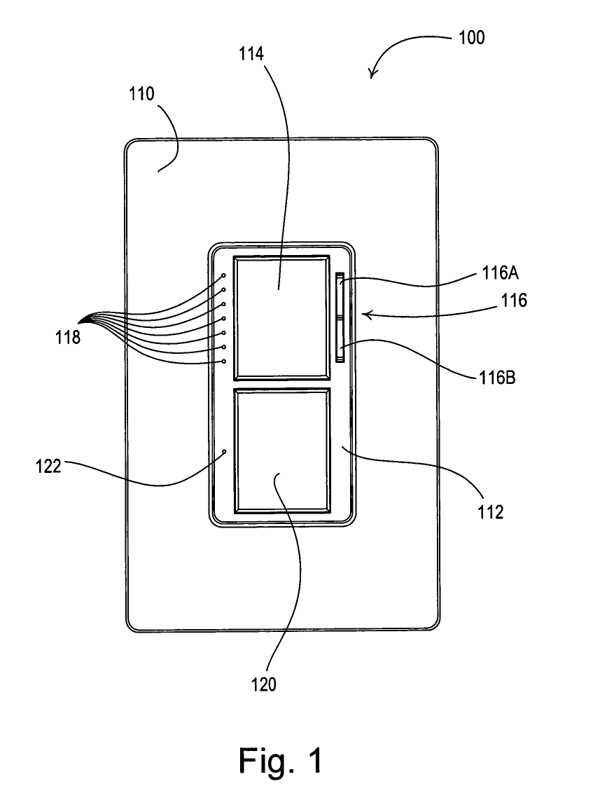

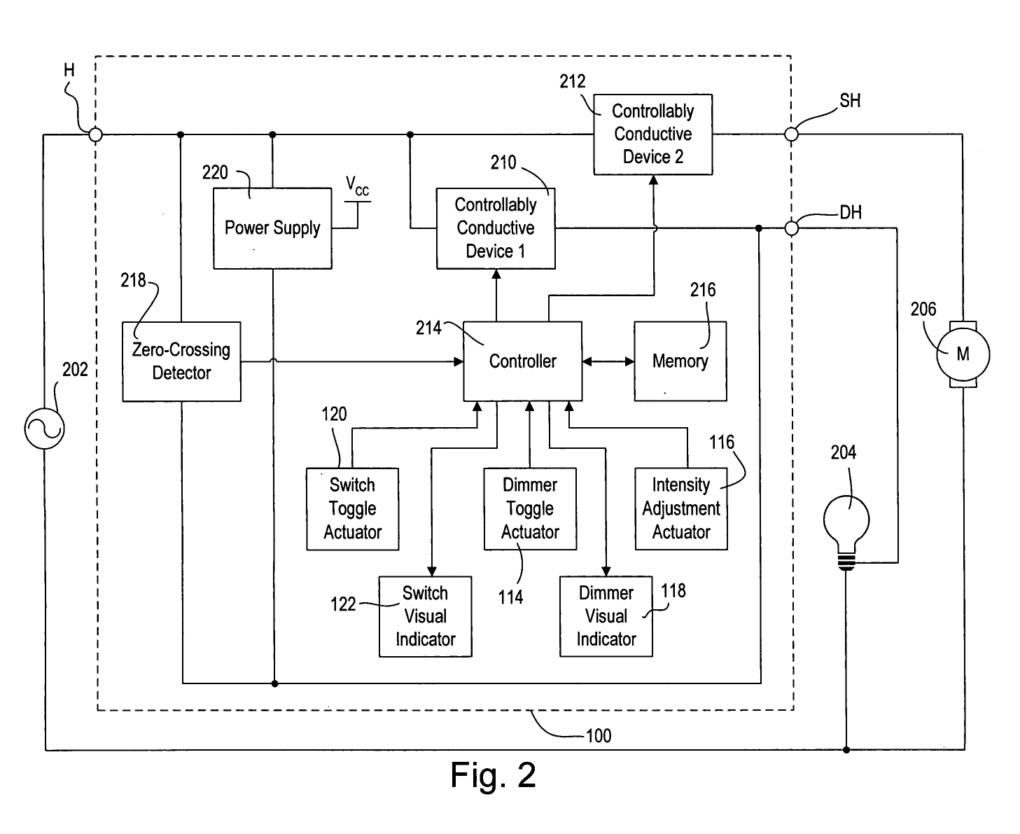

FIG. 1 is a front view of a smart dual switch and dimmer 100 (i.e., a dual “switch/dimmer”) operable to independently control two separate electrical loads according to the present invention. FIG. 2 is a simplified block diagram of the dual switch/dimmer 100. The dual switch/dimmer 100 is operable to control the amount of power delivered from an alternating-current (AC) power source 202 to the first electrical load (e.g., a lighting load 204 shown in FIG. 2) using a phase-control dimming technique. The dual switch/dimmer 100 is further operable to toggle (i.e., switch) a second electrical load (e.g., a motor load 206 shown in FIG. 2) between an on state and an off state.

Referring to FIG. 1, the dual switch/dimmer 100 comprises a faceplate 110 and a bezel 112 received in an opening of the faceplate. The user interface of the dual switch/dimmer 100 includes an upper portion (i.e., a dimmer user interface portion) for controlling the power delivered to the first electrical load and a lower portion (i.e., a switch user interface portion) for switching the second electrical load on and off.

The dimmer user interface portion includes a dimmer toggle actuator 114 (i.e., a button or a switch), a dimmer adjustment actuator 116 (i.e., a rocker switch), and a plurality of dimmer visual indicators 118. When the lighting load 204 is off, an actuation of the dimmer toggle actuator 114 turns the lighting load on to a preset intensity level. When the lighting load 204 is on, an actuation of the dimmer toggle actuator 114 turns the lighting load off (i.e., to 0% light intensity). A double tap of the dimmer toggle actuator 114 (i.e., two transitory actuations of the dimmer toggle actuator in quick succession) turns the lighting load on to a maximum or full intensity (e.g., to 100% light intensity). Actuations of an upper portion 116A or a lower portion 116B of the dimmer adjustment actuator 116 respectively increase or decrease the amount of power delivered to, and thus, the intensity of, the lighting load 204.

The plurality of visual indicators 118 may be implemented as light-emitting diodes (LEDs) and are arranged vertically in a linear array next to the dimmer toggle actuator 114 on the left side of the bezel 112. The visual indicators 118 are illuminated to represent the amount of power being delivered to the lighting load 204 when the load is on. When the lighting load 204 is off, one of the visual indicators 118 is illuminated to display the preset intensity level, while the other visual indicators 118 are illuminated to a dim level to provide a night light feature.

The switch user interface portion includes a switch toggle actuator 120 and a single switch visual indicator 122. Actuations of the switch toggle actuator 120 toggle the second electrical load, i.e., the motor load 206, on and off. The switch visual indicator 122 is illuminated when the second electrical load is on and not illuminated when the load is off.

Referring to FIG. 2, the dual dimmer/switch 100 comprises a hot terminal H coupled to the AC power source 202, a dimmed-hot terminal DH coupled to the lighting load 204, and a switched-hot terminal SH coupled to the motor load 206. The dual dimmer/switch 100 further comprises a first controllably conductive device 210 coupled in series between the AC power source 202 and the lighting load 204 and a second controllably conductive device 212 coupled in series between the AC power source and the motor load 206. Each of the controllably conductive devices 210, 212 may comprise a relay, or any suitable type of bidirectional semiconductor switch, such as, for example, a triac, a field-effect transistors (FET) in a rectifier bridge, or two FETs in anti-series connection. Each of the controllably conductive devices 210, 212 includes a control input for rendering the controllably conductive device 210, 212 conductive or non-conductive, which in turn controls the power supplied to the lighting load 204 and the motor load 206, respectively.

A microprocessor 214 is connected to the control inputs to control the operation of the controllably conductive devices 210, 212. Using a phase-control dimming technique, the microprocessor 214 renders the first controllably conductive device 210 conductive for a portion of each half-cycle to provide power to the lighting load 204, and renders the first controllably conductive device 210 non-conductive for the other portion of the half-cycle to disconnect power from the lighting load 204. In forward phase-control dimming, the first controllably conductive device 210 is conductive at the end of each half-cycle. Alternatively, in reverse-phase control dimming, the first controllably conductive device 210 is conductive at the beginning of each half-cycle.

The microprocessor 214 receives inputs from the dimmer toggle actuator 114, the dimmer adjustment actuator 116, and the switch toggle actuator 120. The microprocessor 214 is further operable to control the dimmer visual indicators 118 and the switch visual indicator 122. The microprocessor 214 is coupled to a memory 216 for storage of the preset intensity. The microprocessor 214 may also be implemented as a programmable logic device (PLD), a microcontroller, an application specific integrated circuit (ASIC), or any suitable type of control circuit.

A zero-crossing detector 218 determines the zero-crossings of the input AC waveform from the AC power supply 202. A zero-crossing is defined as the time at which the AC supply voltage transitions from positive to negative polarity, or from negative to positive polarity, at the beginning of each half-cycle. The zero-crossing information is provided as an input to microprocessor 214. The microprocessor 214 controls the power delivered from the AC power supply 202 to the lighting load 204 using the phase-control dimming technique by controlling the first controllably conductive device 210 to become conductive (and non-conductive) at predetermined times relative to the zero-crossing points of the AC waveform. Accordingly, the controller 214 is operable to gradually apply power to the lighting load 204 and to gradually remove power from the lighting load (i.e. to “fade” the lighting load 204 between the on state and the off state), which is described in greater detail in the '919 patent.

A power supply 220 generates a direct-current (DC) voltage V_{CC} for powering the controller 214, the memory 216, and other low-voltage circuitry of the dual dimmer/switch 100. The power supply 220 is preferably a cat-ear power supply, which draws current only near the zero-crossings of the AC source voltage and derives its name from the shape of the current waveform that it draws from the AC power supply 202. The power supply 220 is coupled in parallel electrical connection with the first controllably conductive device 210. The power supply 220 is operable to draw current from the AC power supply 202 when the voltage developed across the power supply 220 (i.e., across the first controllably conductive device 210) exceeds the DC voltage V_{CC}.

Since the microcontroller 214 controls the first controllably conductive device 210 using a phase-control dimming technique, the first controllably conductive device 210 will be non-conductive at either the beginning or the end of each half-cycle. When the first controllably conductive device 210 is non-conductive, voltage develops across the power supply 220 and the power supply is operable to draw current from the AC power source 202 and through the load 204. To allow the power supply 220 to charge, the first controllably conductive device 210 cannot be turned on for the entire length of a half-cycle, even when the maximum voltage across the lighting load 108 is desired. Accordingly, the lighting load 114 is preferably an electrical load that can be controlled by the phase-control dimming technique, i.e., an electrical load that does not require the full line voltage. For example, the lighting load 114 may be an incandescent load, a magnetic low-voltage (MLV) load, or an electronic low-voltage (ELV) load. Alternatively, the lighting load 114 could also be a non-lighting load, such as a motor load, i.e., a fan motor or an exhaust fan.

Since the power supply 220 is coupled in parallel with the first controllably conductive device 210, the power supply draws current through the lighting load 204. When the microprocessor 214 is controlling the lighting load 204 to off (i.e., the first controllably conductive device 210 is non-conductive), the current drawn by the power supply 220 is preferably not large enough to illuminate the lighting load 204.

The microprocessor 214 is operable to control the second controllably conductive device 212 to simply switch the motor load 206 on and off. To turn the motor load 206 on, the microprocessor 214 controls the second controllably conductive device 212 into full conduction (rather than using the phase-control dimming technique), such that the dual dimmer/switch 100 provides the full source voltage of the AC power source 202 to the motor load 206. Further, since the power supply 220 is not coupled in parallel with the second controllably conductive device 212, the power supply does not draw current through the switched electrical load, i.e., the motor load 206. Accordingly, the dual dimmer/switch 100 provides a “zero-current” off state for the motor load 206, since the power supply 220 does not draw current through the motor load when the motor load is off. Even though the second electrical load is shown as a motor load 206 in FIG. 2, the second electrical load could alternatively be any type of electrical load since the dual dimmer switch 100 provides the full line voltage to the second electrical load in the on state and zero current through the second electrical load in the off state. For example, the second electrical load could be an incandescent load, an MLV load, an ELV load, a light-emitting diode (LED) fixture or a compact fluorescent lamp (CFL).

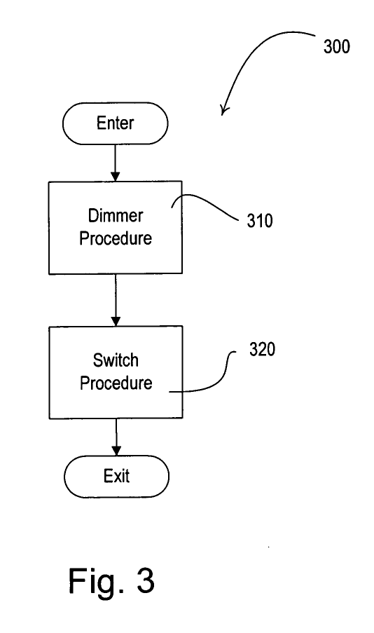

FIG. 3 is a flowchart of a control procedure 300 executed periodically by the microprocessor 214. First, during a dimmer procedure 310, the microprocessor 214 checks the inputs provided by the dimmer toggle actuator 114 and the dimmer adjustment actuator 116, and controls the lighting load 204 and the dimmer visual indicators 118 accordingly. Next, the microprocessor 214 checks the input of the switch toggle actuator 120 and appropriately controls the lighting load 204 and the switch visual indicator 122 during a switch procedure 320.

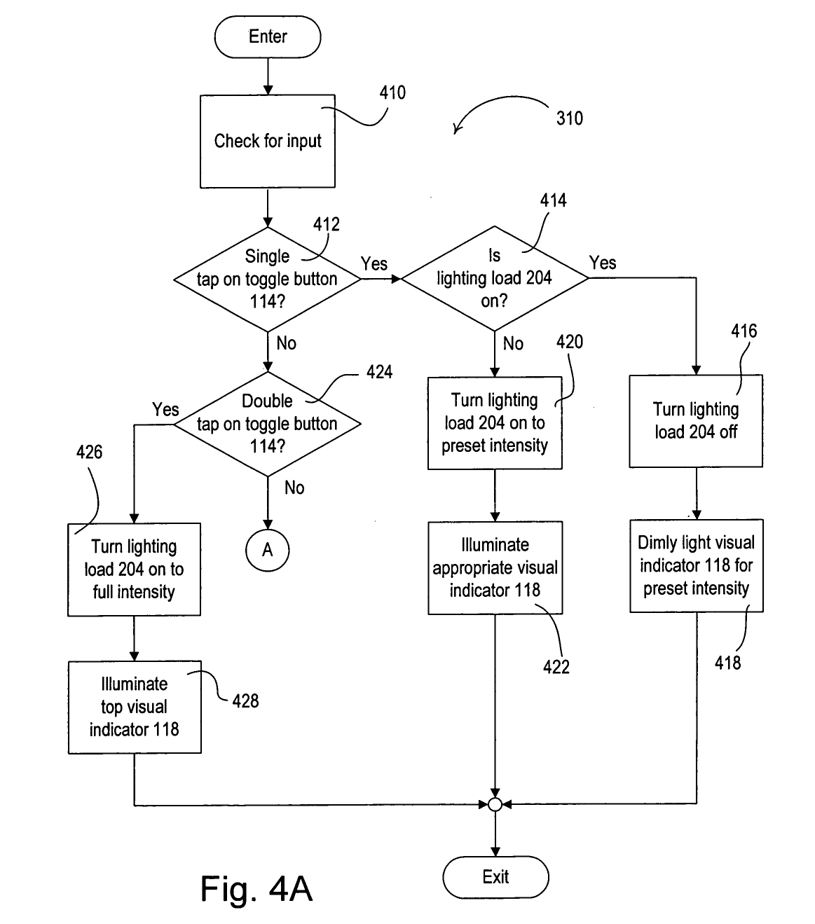

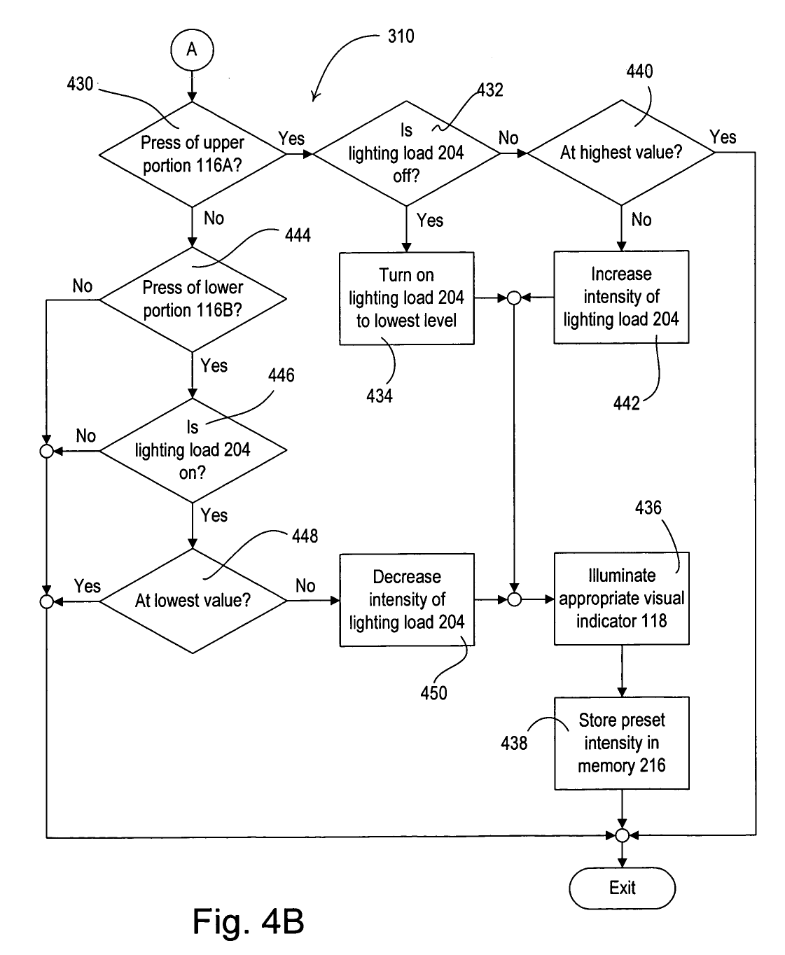

FIGS. 4A and 4B are flowcharts of the dimmer procedure 310. First, the microprocessor 214 checks the inputs from the dimmer toggle actuator 114 and the dimmer adjustment actuator 116 at step 410. If a single tap of the dimmer toggle actuator 114 is detected at step 412 and the lighting load 204 is off at step 414, the microprocessor 214 turns the lighting load on to the preset intensity at step 420, illuminates the appropriate visual indicator 118 (i.e., representing the preset intensity) at step 422, and exits the dimmer procedure 310. If the lighting load 204 is on at step 414, the microprocessor 214 turns the lighting load off at step 416. At step 418, the microprocessor 214 dimly illuminates the appropriate visual indicator 118 to a first dim level to represent the preset intensity, while dimly illuminating the other visual indicators 118 to a second dim level less than the first dim level. For example, the middle visual indicator is dimly illuminated to the first level if the preset intensity is approximately 50%.

If a single-tap of the dimmer toggle actuator 114 is not detected at step 412, but a double-tap of the dimmer toggle actuator is detected at step 424, the microprocessor 214 turns the lighting load 204 on to full intensity, i.e., substantially 100% light intensity, at step 426, illuminates the top visual indicator at step 428, and exits the dimmer procedure 310.

If a double-tap of the dimmer toggle actuator 114 is not detected at step 424, a determination is made at step 430 as to whether the upper portion 116A of the dimmer adjustment actuator 116 has been actuated. If an actuation of the upper portion 116A is detected at step 430 and the lighting load 204 is off at step 432, the microcontroller 214 turns the lighting load on to the lowest level (e.g., 1%) at step 434. Next, the appropriate visual indicator 118 is illuminated at step 436, the present intensity of the lighting load 204 is stored in the memory 216 as the preset intensity level at step 438, and the dimmer procedure 310 exits. If the lighting load is on at step 432 and the intensity of the lighting load 204 is at the highest value (e.g., 100%) at step 440, the dimmer procedure 310 exits. If the lighting load 204 is not at the highest value at step 440, the microprocessor 214 increases the intensity of the lighting load 204 at step 442, illuminates the appropriate visual indicator 118 at step 436, and stores the present intensity level in the memory 216 at step 438.

If an actuation of the upper portion 116A of the dimmer adjustment actuator 116 is not detected at step 430, a determination is made at step 444 as to whether the lower portion 116B of the dimmer adjustment actuator 116 has been actuated. If the lower portion 116B of the dimmer adjustment actuator 116 is detected at step 444, if the lighting load is on at step 446, and if the intensity of the lighting load 204 is not at the lowest level at step 448, the microprocessor 214 decreases the intensity of the lighting load 204 at step 450. Then, the microprocessor 214 illuminates the appropriate visual indicator 118 at step 436 and stores the present intensity level of the lighting load 204 as the preset intensity level at step 438. If an actuation of the lower portion 116B of the dimmer adjustment actuator 116 is not detected at step 444, or the lighting load 204 is not on at step 446, or the intensity of the lighting load 204 is at the lowest level at step 448, the dimmer procedure 310 simply exits.

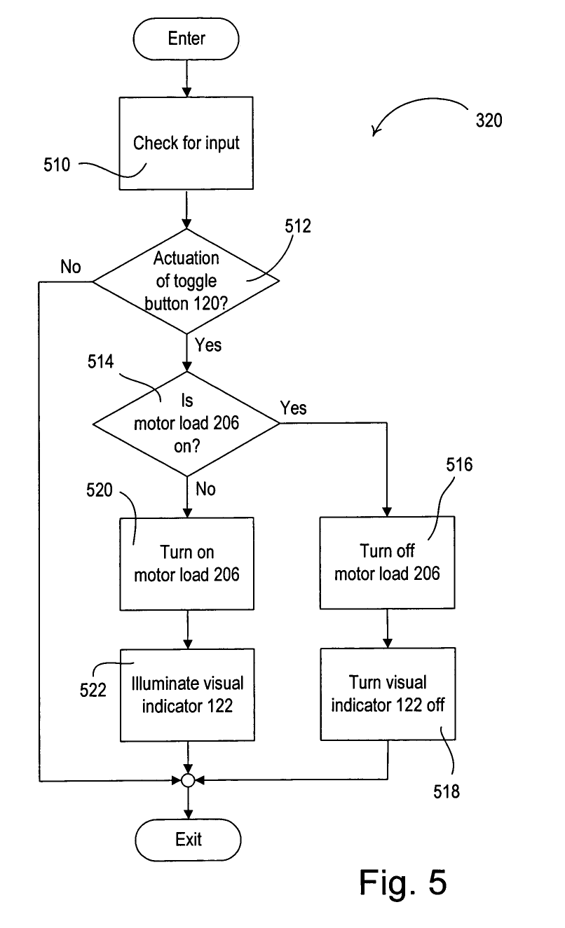

FIG. 5 is a flowchart of the switch procedure 320 executed as part of the control procedure 300 of FIG. 3. At step 510, the microprocessor 214 checks the input from the switch toggle actuator 120. If an actuation of the switch toggle actuator 120 is detected at step 512 and the motor load 206 is on at step 514, the microprocessor 214 turns the motor load off at step 516 and turns the visual indicator 122 off at step 518. If the motor load 206 is off at step 514, the microprocessor 214 turns the motor load on at step 522 and turns the visual indicator 122 on at step 522. If an actuation of the switch toggle actuator 120 is not detected at step 512, the switch procedure 320 simply exits.

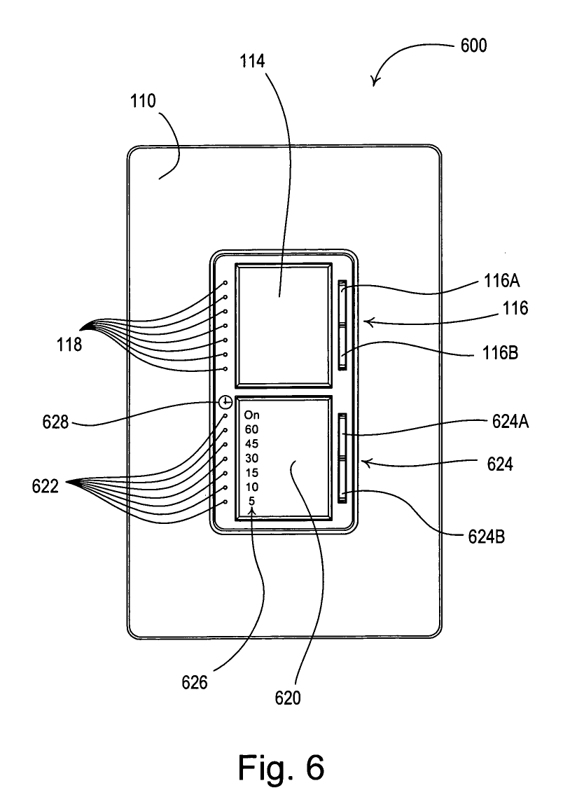

FIG. 6 is a front view of a dual electrical timer and dimmer 600 (i.e., a dual “timer/dimmer”) operable to control two separate electrical loads according to a second embodiment of the present invention. The dual timer/dimmer 600 is operable to control the amount of power delivered from the AC power source 202 to the first electrical load, i.e., the lighting load 204, using a phase-control dimming technique. The dual timer/dimmer 600 is further operable to turn on a second electrical load, i.e., the motor load 206, and to subsequently automatically turn off the second electrical load after a predetermined amount of time (i.e., a preset timeout period) has elapsed.

The user interface of the dual timer/dimmer 600 includes an upper portion (i.e., the dimmer user interface portion comprising the dimmer toggle actuator 114, the dimmer adjustment actuator 116, and the plurality of dimmer visual indicators 118) for controlling the power delivered to the first electrical load. The user interface also includes a lower portion (i.e., a timer user interface portion) for controlling the second electrical load on and off and the value of the preset timeout period.

The dual timer/dimmer 600 comprises a timer toggle actuator 620 and a timer adjustment actuator 624, i.e., a rocker switch. Actuations of the toggle actuator 620 toggle, i.e., turn off and on, the second electrical load. Actuations of an upper portion 624A or a lower portion 624B of the timer adjustment actuator 624 respectively increase or decrease the preset timeout period of the dual timer/dimmer 600. A plurality of timer visual indicators 622, e.g., light-emitting diodes (LEDs), are arranged in a vertical linear array to the left side of the of the timer toggle actuator 620. The timer visual indicators 622 are illuminated to represent the present value of the preset timeout period, or to display the amount of time left until the second electrical load is turned off. A column of labels 626 are engraved into the timer toggle actuator 620 next to the visual indicators 622 and may comprise numerical representations of the possible preset timeout periods that the associated visual indicator 622 represents. The dual timer/dimmer 600 may further comprise a timer icon 628 above the linear array of visual indicators 622.

When the second electrical load is off, a user of the dual timer/dimmer 600 may determine a desired amount of time for the preset timeout period, i.e., the amount of time that the second electrical load will remain on after the second electrical load is turned on. Accordingly, the user may actuate the upper and lower portions 624A, 624B of the timer adjustment actuator 624 to select one of a plurality of predetermined values of the timeout period, e.g., five (5) minutes, ten (10) minutes, fifteen (15) minutes, thirty (30) minutes, forty-five (45) minutes, and sixty (60) minutes, as shown in FIG. 6. As the user actuates the timer adjustment actuator 624, the dual timer/dimmer 600 offers a pre-on visual feedback by illuminating one of the visual indicators 622 to designate the present value of the timeout period. For example, if the middle visual indicator 622 next to the text ‘30’ is illuminated, the timeout period will be thirty (30) minutes. Note that actuation of the timer adjustment actuator 624 does not cause the second electrical load to turn on.

After selecting the desired timeout period, the user can turn on the second electrical load by actuating the timer toggle actuator 620. At this time, the dual timer/dimmer 600 enters a countdown mode and starts a countdown timer having an initial value equal to the desired timeout period. The dual timer/dimmer 600 illuminates the visual indicator 622 that corresponds to the desired timeout period. As the countdown timer decreases, the dual timer/dimmer 600 illuminates one of the visual indicators 622 to represent the amount of time left until the second electrical load is turned off. For example, if there are ten (10) minutes left in the countdown timer, the dual timer/dimmer 600 illuminates the visual indicator 622 adjacent the text ‘10’ on the timer toggle actuator 620. As the countdown timer is counting down to zero, the dual timer/dimmer 600 preferably provides an animated visual feedback, i.e., the dual timer/dimmer illuminates the visual indicators 622 to show that the countdown timer is actively counting down to zero.

When there is a small amount of time left in the countdown timer, e.g., one (1) minute, the dual timer/dimmer 600 provides a pre-off visual feedback by blinking the bottom visual indicator quickly, i.e., at a second rate faster than the first rate (e.g., on for one-fourth second and off for one-fourth second), to warn the user that the second electrical load is about to turn off. When the countdown timer expires, i.e., after the desired timeout period has elapsed, the timer/dimmer 600 turns the second electrical load off.

According to the present invention, when the second electrical load is turned off, the dual timer/dimmer 600 remembers the last timeout period that was selected by the user, i.e., the preset timeout period, such that the electronic timer will use the preset timeout period when the timer toggle actuator 620 is subsequently actuated. Accordingly, the visual indicator 622 representing the preset timeout period is dimly illuminated when the second electrical load is off. The user may decide to keep the preset timeout period and simply turn the second electrical load on with the selected preset timeout period. Or the user may decide to adjust the timeout period using the timer adjustment actuator 624 to a different timeout period and then turn the second electrical load on. Thus, the dual timer/dimmer 600 according to the present invention provides a one-button recall of the preset timeout period, i.e., one actuation of the timer toggle actuator 620 when the second electrical load is off starts the countdown timer with the preset timeout period.

The dual timer/dimmer 600 is also operable to enter a bypass mode in which the countdown timer is disabled and power is continuously (i.e., indefinitely) provided to the second electrical load. The dual timer/dimmer 600 enters the bypass mode in response to a number of possible actuations of the timer toggle actuator 620 and the timer adjustment actuator 624. First, when the second electrical load is off, the user may use the timer adjustment actuator 624 to highlight the top visual indicator 622 in the linear array (next to the ‘On’ label 120 as shown in FIG. 1), and subsequently press the timer toggle actuator 620 once to enter the bypass mode. When the second electrical load is on and the countdown timer is enabled, the user may use the timer adjustment actuator 624 to highlight the top visual indicator 622 and the dual timer/dimmer instantly changes to the bypass mode. Finally, the dual timer/dimmer 600 is operable to enter the bypass mode in response to a double-tap of the timer toggle actuator 620, i.e., two transitory actuations of the timer toggle actuator 620 in quick succession. To differentiate between when the dual timer/dimmer 600 is in the bypass mode rather than counting down for the timeout period, the top visual indicator 622 is preferably a different color than the other visual indicators of the linear array, for example, the top visual indicator may be green, while the other visual indicators may be orange. When the dual timer/dimmer 600 is in the bypass mode, the user may actuate the timer toggle actuator 620 once to turn off the second electrical load.

An example of a load control device having a similar timer functionality is described in greater detail in co-pending commonly-assigned U.S. patent application, Attorney Docket No. 06-12715-P2, filed Sep. 13, 2006, entitled WALL-MOUNTABLE TIMER FOR AN ELECTRICAL LOAD, the entire disclosure of which is hereby incorporated by reference.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A wall-mountable load control device for individually controlling the power delivered from an AC power source to a first electrical load and a second electrical load, the AC power source having a hot connection and a neutral connection, the first and second electrical loads each having a first connection and a second connection, the second connections of both the first and second electrical loads coupled to the neutral connection of the AC power source, the load control device comprising:
a first controllably conductive device adapted to be coupled between the hot connection of the AC power source and the first connection of the first electrical load for controlling the amount of power delivered to the first electrical load continuously from a maximum value to a minimum value, the first controllably conductive device having a control input;
a second controllably conductive device adapted to be coupled between the hot connection of the AC power source and the first connection of the second electrical load for switching the second electrical load between an on state and an off state, the second controllably conductive device having a control input;
a control circuit coupled to the control inputs of the first and second controllably conductive devices; the control circuit operable to control the first and second controllably conductive devices; and
a power supply operable to generate a DC voltage for powering the control circuit, the power supply coupled in parallel electrical connection with the first controllably conductive device, such that the power supply is operable to draw current through the first electrical load;
wherein the second controllably conductive device is operable to provide substantially zero current through the second electrical load when the second electrical load is in the off state; and
further wherein the load control device is not adapted to be coupled to the neutral connection of the AC power source.

2. The load control device of claim 1, further comprising:
a user interface coupled to the control circuit;
wherein the user interface comprises a first user interface portion and a second user interface portion, and the control circuit is operable to control the first controllably conductive device in response to inputs received via the first user interface portion and to control the second controllably conductive device in response to inputs received via the second user interface portion.

3. The load control device of claim 2, wherein the control circuit is operable to enable the delivery of power to the second electrical load in response to the inputs received via the second user interface portion, and subsequently prevent the delivery of power to the second electrical load automatically when a preset timeout period has elapsed.

4. The load control device of claim 3, wherein the first user interface portion comprises a dimmer toggle actuator and a dimmer adjustment actuator, and the control circuit is operable to switch the first electrical load on and off in response to an actuation of the dimmer toggle actuator and to control the amount of power delivered to the first electrical load in response to an actuation of the dimmer adjustment actuator; and
further wherein the second user interface portion comprises a timer toggle actuator and a timer adjustment actuator, and the control circuit is operable to set the preset timeout period in response to an actuation of the timer adjustment actuator and to enable the delivery of power to the second electrical load in response to a first actuation of the timer toggle actuator.

5. The load control device of claim 4, wherein the control circuit is operable to discontinue the delivery of power to the second electrical load in response to a second actuation of the timer toggle actuator.

6. The load control device of claim 4, wherein the control circuit is operable to enter a bypass mode in response to a second actuation of the timer toggle actuator, the second actuation comprising a double tap of the timer toggle actuator, whereby the second electrical load is indefinitely turned on in the bypass mode.

7. The load control device of claim 4, wherein the first user interface portion comprises a plurality of dimmer visual indicators operable to display a representation of the amount of power being delivered to the first electrical load, and the second user interface portion comprises a plurality of timer visual indicators operable to display a representation of the present value of the preset timeout period or the amount of time left until the second electrical load is turned off

8. The load control device of claim 2, wherein the first user interface portion comprises a dimmer toggle actuator and a dimmer adjustment actuator, and the control circuit is operable to switch the first electrical load on and off in response to an actuation of the dimmer toggle actuator and to control the amount of power delivered to the first electrical load in response to an actuation of the dimmer adjustment actuator; and
further wherein the second user interface portion comprises a switch toggle actuator, and the control circuit is operable to switch the second electrical load on and off in response to an actuation of the switch toggle actuator.

9. The load control device of claim 8, wherein the first user interface portion comprises a plurality of dimmer visual indicators operable to display a representation of the amount of power being delivered to the first electrical load, and the second user interface portion comprises a single switch visual indicator operable to illuminate when the second electrical load is on.

10. The load control device of claim 1, wherein the first controllably conductive device comprises a bidirectional semiconductor switch.

11. The load control device of claim 10, wherein the first electrical load comprises a lighting load.

12. The load control device of claim 11, wherein the controller is operable to control the first controllably conductive device so as to gradually apply power to the lighting load and to gradually remove power from the lighting load.

13. The load control device of claim 10, wherein the bidirectional semiconductor switch comprises a triac.

14. The load control device of claim 10, wherein the bidirectional semiconductor switch comprises a FET in a rectifier bridge.

15. The load control device of claim 10, wherein the bidirectional semiconductor switch comprises two FETs in anti-series connection.

16. The load control device of claim 10, wherein the second controllably conductive device comprises a bidirectional semiconductor switch.

17. The load control device of claim 10, wherein the second controllably conductive device comprises a relay.

18. The load control device of claim 1, wherein the control circuit comprises a microprocessor.

19. The load control device of claim 1, wherein the power supply comprises a cat-ear power supply.

20. The load control device of claim 1, further comprising:
a plurality of terminals, consisting of:
a first terminal adapted to be coupled to the AC power source;
a second terminal adapted to be coupled to the first electrical load;
a third terminal adapted to be coupled to the second electrical load;
wherein the first controllably conductive device is operatively coupled between the first terminal and the second terminal, and the second controllably conductive device is operatively coupled between the first terminal and the third terminal.

21. A wall-mountable load control device for controlling the power delivered from an AC power source independently to a first electrical load and a second electrical load, the load control device comprising:
a plurality of terminals, consisting of:
a first terminal adapted to be coupled to the AC power source;
a second terminal adapted to be coupled to the first electrical load;
a third terminal adapted to be coupled to the second electrical load;
a first controllably conductive device operatively coupled between the first terminal and the second terminal, the first controllably conductive device having a control input;
a second controllably conductive device operatively coupled between the first terminal and the third terminal, the second controllably conductive device having a control input; and
a control circuit coupled to the control inputs of the first and second controllably conductive devices, the control circuit operable to control each of the first and second controllably conductive devices independently between a conductive state and a non-conductive state;
wherein the second controllably conductive device is operable to provide substantially zero current through the second electrical load when the second controllably conductive device is in the non-conductive state.

22. The load control device of claim 21, further comprising:
a user interface coupled to the control circuit;
wherein the user interface comprises a first user interface portion and a second user interface portion, and the control circuit is operable to control the first controllably conductive device in response to inputs received via the first user interface portion and to control the second controllably conductive device in response to inputs received via the second user interface portion.

23. The load control device of claim 22, wherein the control circuit is operable to enable the delivery of power to the second electrical load in response to the inputs received via the second user interface portion, and subsequently prevent the delivery of power to the second electrical load automatically when a preset timeout period has elapsed.

24. The load control device of claim 23, wherein the first user interface portion comprises a dimmer toggle actuator and a dimmer adjustment actuator, and the control circuit is operable to switch the first electrical load on and off in response to actuations of the dimmer toggle actuator and to control the amount of power delivered to the first electrical load in response to an actuation of the dimmer adjustment actuator; and
further wherein the second user interface portion comprises a timer toggle actuator and a timer adjustment actuator, and the control circuit is operable to operable to set the preset timeout period in response to an actuation of the dimmer adjustment actuator and to enable the delivery of power to the second electrical load in response to a first actuation of the timer toggle actuator.

25. The load control device of claim 24, wherein the control circuit is operable to discontinue the delivery of power to the second electrical load in response to a second actuation of the timer toggle actuator.

26. The load control device of claim 24, wherein the control circuit is operable to enter a bypass mode in response to a second actuation of the timer toggle actuator, the second actuation comprising a double tap of the timer toggle actuator, whereby the second electrical load is indefinitely turned on in the bypass mode.

27. The load control device of claim 24, wherein the first user interface portion comprises a plurality of dimmer visual indicators operable to display a representation of the amount of power being delivered to the first electrical load, and the second user interface portion comprises a plurality of timer visual indicators operable to display a representation of one of the present value of the preset timeout period and the amount of time left until the second electrical load is turned off

28. The load control device of claim 22, wherein the first user interface portion comprises a dimmer toggle actuator and a dimmer adjustment actuator, and the control circuit is operable to switch the first electrical load on and off in response to an actuation of the dimmer toggle actuator and to control the amount of power delivered to the first electrical load in response to an actuation of the dimmer adjustment actuator; and
further wherein the second user interface portion comprises a switch toggle actuator, and the control circuit is operable to switch the second electrical load on and off in response to an actuation of the switch toggle actuator.

29. The load control device of claim 28, wherein the first user interface portion comprises a plurality of dimmer visual indicators operable to display a representation of the amount of power being delivered to the first electrical load, and the second user interface portion comprises a single switch visual indicator operable to illuminate when the second electrical load is on.

30. The load control device of claim 21, wherein the first controllably conductive device comprises a bidirectional semiconductor switch.

31. The load control device of claim 30, wherein the first electrical load comprises a lighting load.

32. The load control device of claim 31, wherein the controller is operable to control the first controllably conductive device so as to gradually apply power to the lighting load and to gradually remove power from the lighting load.

33. The load control device of claim 30, wherein the bidirectional semiconductor switch comprises a triac.

34. The load control device of claim 30, wherein the bidirectional semiconductor switch comprises a FET in a rectifier bridge.

35. The load control device of claim 30, wherein the bidirectional semiconductor switch comprises two FETs in anti-series connection.

36. The load control device of claim 30, wherein the second controllably conductive device comprises a bidirectional semiconductor switch.

37. The load control device of claim 30, wherein the second controllably conductive device comprises a relay.

38. The load control device of claim 21, further comprising:
a power supply operable to generate a DC voltage for powering the control circuit, the power supply coupled in parallel electrical connection with the first controllably conductive device, such that the power supply is operable to draw current through the first electrical load.

39. The load control device of claim 38, wherein the power supply comprises a cat-ear power supply.

40. The load control device of claim 21, wherein the control circuit comprises a microprocessor.
